(19) United States
(12) Patent Application Publication
(10) Pub. No.: US 2026/0181026 A1
(43) Pub. Date: Jun. 25, 2026

(54) CALL HANDLING SYSTEMS AND METHODS

(71) Applicant: Telefonaktiebolaget LM Ericsson (publ), Stockholm (SE)

(72) Inventors: David CASTELLANOS ZAMORA, Madrid (ES); Dan XU, Gothenburg (SE); HåKAN ÖSTERLUND, Ekerö (SE)

(73) Assignee: Telefonaktiebolaget LM Ericsson (publ), Stockholm (SE)

(21) Appl. No.: 19/127,430

(22) PCT Filed: Nov. 3, 2023
(86) PCT No.: PCT/EP2023/080629

§ 371 Date: May 6, 2025

Related U.S. Application Data
(60) Provisional application No. 63/423,156, filed on Nov. 7, 2022.

(51) Int. Cl. H04L 65/1016; H04L 9/40; H04L 65/1069; H04L 65/1104; H04L 67/306

(52) U.S. Cl. CPC H04L 65/1016; H04L 63/102; H04L 65/1069; H04L 65/1104; H04L 67/306

(57) ABSTRACT

A method for handling a call from a calling device. The method includes receiving a call initiation message (e.g., SIP INVITE message) for setting up a call between the calling device (e.g., PBX or SIP UA) and a callee device, the call initiation message comprising a user identity (e.g., an IMPU). The method also includes, after receiving the call initiation message, determining whether user information associated with the user identity indicates that use of a third-party, 3P, identifier, ID, is authorized.

### TECHNICAL FIELD

Disclosed are embodiments related to systems and method for call handling.

### BACKGROUND

There are scenarios in which a user of an Internet Protocol (IP) Multimedia System (IMS) subscription (e.g., employees of an enterprise which uses IMS for communication services) uses a third party (3P) identifier (ID) (e.g., enterprise employee ID including full name of the employee, name of enterprise, title, enterprise location, etc.) when making a call to a callee. The IMS network can present the 3P ID to the callee during subsequent calling process. The user (e.g., third-party subscriber) (a.k.a., the “caller”) can access the IMS network directly or via a Session Initiation Protocol (SIP) trunk as well.

The Third Generation Partnership Project (3GPP) Technical Report (TR) 33.890 version 0.3.0 (hereafter “TR 33.890”) (see 3GPP Technical Document (Tdoc) S3-222958) describes a “Key Issue #1” that covers the study for the enhanced IMS network to be able to support the verification and authorization of a user during an IMS call. The goal is that, for example, a malicious device (a.k.a., user equipment (UE)) cannot use 3P IDs belonging to others (employees) or forged IDs to initiate IMS calls in the IMS network or use a 3P ID that no longer belongs to the caller to initiate IMS calls in the IMS network (e.g., the user uses the ID allocated by a particular company even after the user has left the company). TR 33.890 proposes a solution based on the presence of a database that keeps the relation of the 3P ID and each user's IMS identity used within the IMS domain (i.e. each user's IMS private user identity (IMPI) and/or the IMS public user identity (IMPU)) (see, e.g., step 3 in FIG. 1, which is a copy of FIG. 6.1.2.2-1 from TR 33.890).

Typically, an integrated circuit card (ICC), such as a Universal ICC (UICC), within a device configured to utilize an IMS includes an application known as the IMS Identity Module (ISIM) and this application contains parameters for identifying and authenticating the device to the IMS. Among the data present on ISIM are an IMPI and at least one IMPU. The IMPI is an identity allocated by the home network and contains the home operator's domain information. The IMPU acts like a telephone number. A relationship between IMPIs and IMPUs is also described in 3GPP Technical Specification (TS) 23.228 V 17.3.0 (“TS 23.228”) and illustrated in FIG. 4.5 of TS 23.228, which shows an “IMS Subscription” containing a single Private User Identity and a set of one or more Public User Identifies associated with the Private User Identity. According to clause 4.3.3.1 of TS 23.228, “[e] very IM CN subsystem user shall have one or more Private User Identities. The private identity is assigned by the home network operator, and used, for example, for Registration, Authorization, Administration, and Accounting purposes,” and according to clause 4.3.3.2 “[e] very IM CN subsystem user shall have one or more Public User Identities including at least one taking the form of a SIP URI. The Public User Identity is used by any user for requesting communications to other users.” As noted in TS 23.228 “[i] t shall be possible to support a wild carded Public User Identity. A wild carded Public User Identity expresses a set of Public User Identities grouped together.”

The message flow shown in FIG. 1 includes thirteen steps, which are described in TR 33.890 and described below:
1. The 3rd party (3P) PBX (Private Branch Exchange) sends a SIP INVITE that contains the IMS Identity of the calling UE (i.e., the IMPU of the calling UE) (also contains IMPU of the callee UE) and that may or may not contain a third party (3P) ID on behalf of 3P subscriber to Interconnect Border Control Function (IBCF).
2. The IBCF forwards the SIP request to the originating IMS subsystem entity. The IMS subsystem entity includes: an I-CSFC, S-CSCF, MMtel AS, etc.
3. The originating IMS subsystem checks whether the IMS subscription of the calling PBX is authorized (i.e. allowed) to use 3P IDs. If the PBX is not authorized to use 3P IDs, then the originating IMS subsystem ignores the 3P ID within the SIP INVITE (if present) and do not execute the rest of 3P ID related steps during the call set-up. The call continues without presenting 3P ID to the called endpoint. If the PBX is authorized to use 3P IDs, the originating IMS subsystem gets Rich Call Data (RCD) of 3P subscriber from the Database based on the received IMS identity (IMPU). If no RCD data exists for this user (IMS identity), the rest of 3P ID related steps are not executed during the call set-up. The call continues without presenting 3P ID to the called endpoint. NOTE: if no 3P ID is received in the SIP INVITE from the PBX, suppression of a Database lookup can be optionally applied based on a local policy. If there is a mismatch between the received 3P ID in the SIP INVITE and data retrieved from the Database based on the IMS identity, it is governed by a local policy of the originating IMS subsystem how the population of the Rich Call Data into the SIP Identity header will be done.
4. The originating IMS subsystem adds a P-Asserted-Identity header field asserting the telephone number and Rich Call Data of the 3P subscriber and invokes the STI-AS (Secure Telephone Identity Authentication Service) to sign the Identity header based on FIG. 6.X.2.1-2: SHAKEN Reference Architecture and TS 24.229 [4].
5. STI-AS interacts with SKS (not shown in the figure) and signs the SIP identity header according to STIR/SHAKEN framework and draft-ietf-stir-passport-rcd-18.
6. STI-AS returns the signed SIP identity header back to IMS subsystem.
7. The originating IMS subsystem, through standard solution, routes the call to the egress IBCF. Then SIP INVITE is routed over the NNI through the standard inter-domain routing configuration. The terminating service provider's ingress IBCF receives the INVITE and forwards to terminating IMS subsystems.
8. The terminating IMS subsystem entity invokes the STI-VS (Secure Telephone Identity Verification Service) to verify the signed SIP identity header
9. STI-VS validates the certificate and extracts public key and verify the signature in the Identity header field, which validates the Caller ID and Rich Call Data when signing the INVITE on the originating STI-AS based on FIG. 6.X.2.1-2: SHAKEN Reference Architecture and TS 24.229 [4].
10. Depending on the result of the STI validation, STI-VS determines that the call is to be completed with an appropriate indicator and the result is passed back to terminating IMS subsystem which continues to set up the call to the terminating SIP UA. If the Caller ID is validated OK but not the rich call data, the call can continue but without showing name card info to terminating SIP UA.
11. The SIP INVITE with verstat parameter is sent to terminating SIP User Agent (UA).
12. The terminating SIP UA sends 18X and 200 to originating IMS subsystem.
13. Originating IMS subsystem sends 18X and 200 to originating SIP UA. The call continues following standard solution.

### SUMMARY

Certain challenges presently exist. For instance, before an originating IMS subsystem contacts a database to verify the third-party ID (3P ID) in step 3 of FIG. 1, step 3 includes an authorization step to make sure that the IMS subscription can use 3P IDs in the first place, but how the originating IMS subsystem performs this authorization is not yet defined.

Accordingly, in one aspect there is provided a method for handling a call from a calling device. The method includes receiving a call initiation message (e.g., SIP INVITE message) for setting up a call between the calling device (e.g., PBX or SIP UA) and a callee device, the call initiation message comprising a user identity (e.g., an IMPU). The method also includes, after receiving the call initiation message, determining whether user information associated with the user identity indicates that use of a 3P ID is authorized.

In another aspect there is provided a method performed by a subscriber server. The method includes receiving user information comprising a user identity and a first 3P allowed indicator value associated with the user identity for indicating whether or not use of a 3P ID is authorized. The method also includes storing the user information. The method also includes receiving, from an IMS subsystem entity, a request message requesting the user information. The method further includes transmitting to the IMS subsystem entity a response message responsive to the request message, wherein the response message comprises the user information.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of the embodiments disclosed herein is that they utilize a subscriber system (e.g., the Home Subscriber System (HSS)) within the IMS subsystem to manage the subscription profiles that define the IMS services enabled for the users of the IMS subscriptions. The embodiments have minimal impact on IMS procedures.

### BRIEF DESCRIPTION OF THE DRAWINGS

The accompanying drawings, which are incorporated herein and form part of the specification, illustrate various embodiments.

FIG. 1 illustrates a message flow for establishing a call.

FIG. 2 illustrates a registration message flow.

FIG. 3 illustrates a message flow for establishing a call according to some embodiments.

FIG. 4 illustrates a message flow for establishing a call according to some embodiments.

FIG. 5 is a flowchart illustrating a process according to some embodiments.

FIG. 6 is a block diagram of an apparatus according to some embodiments.

FIG. 7 is a flowchart illustrating a process according to some embodiments.

### DETAILED DESCRIPTION

This disclosure provides means for an originating IMS subsystem to perform an authorization check of whether a calling device associated with an IMS subscription can make use of 3P IDs. In one embodiment, the originating IMS subsystem performs the authorization check using user information associated with a user identity included in the call initiation message (e.g. SIP INVITE message). Accordingly, in some embodiments, new information is defined in the user information (e.g., IMS subscription profile) managed in the HSS of the originating IMS subsystem which user information is provided to a Server-Call Session Control Function, S-CSCF, during registration of the IMPI in the IMS. In these embodiments, the enforcement of the authorization is then executed in the S-CSCF during IMS session set up.

### 3P Allowed Indicator Definition

There are different ways to indicate within the user information associated with an IMS identity whether use of 3P IDs is authorized for the IMS identity. For example, a “3P allowed” indicator can be added to the user information (IMS subscription profile) and used to provide an indication of whether use of a 3P ID is allowed or not (e.g., when the value of the indicator is set to 1 or TRUE, then this indicates that 3P IDs are allowed, otherwise 3P IDs are not allowed). The 3P allowed indicator can be defined within the IMS subscription profile at the IMPI level, meaning that all IMPUs associated to the IMS subscription (e.g. all users behind a PBX client) will be authorized or not to use 3P IDs. Absence of the 3P allowed indicator at IMPI level is understood as none of the IMPUs associated to the IMPI are allowed to make use of 3P IDs. For example, the user information (e.g., IMS subscription profile) associated with a particular IMPU may include an IMPI, the particular IMPU, and zero or more other IMPUs. When the 3P allowed indicator is defined at the IMPI level, the indicator is associated with the IMPI (e.g., included in metadata linked to the IMPI in the user information).

Additionally, when the value of the 3P allowed indicator defined at IMPI level authorizes the use of 3P IDs, it is possible to explicitly exclude some IMPUs from the authorization by explicitly setting another 3P ID indication at IMPU level to the value to not authorized. For example, consider an IMS subscription profile that includes an IMPI, a first IMPU; and a second IMPU; in this example assume a first 3P allowed indicator is at the IMPI level and is set to 1 to indicate 3P IDs are allowed, but another 3P allowed indicator is associated with the first IMPU indicates that 3P IDs are not allowed; in this scenario 3P IDs are not allowed for the first IMPU but are allowed for the second IMPU because there is no 3P allowed indicator associated with the second IMPU indicating that 3P IDs are not allowed.

In one embodiment, the 3P allowed indicator may be a “display name.” That is, if any particular IMPU within the IMS subscription profile is associated with a display name, then this indicates that 3P IDs are allowed for the particular IMPU. However, when wild-carded IMPUs are used (e.g. as in the PBX case), it is not possible that the “display name” includes an individualized 3P ID for each individual IMPU within the wild-carded IMPU set. In this case, the “display name” may simply be set to a value that indicates that any particular IMPU within the set is authorized to use 3P IDs (if a particular IMPU is authorized to use a 3P ID, the IMS subsystem can obtain a 3P ID associated with the IMPU from a Rich Call Data (RCD) database. That is, the “display name” associated to the wild-carded IMPU or any individual IMPU can be set to the value e.g. “/RCD/” or similar value to indicate that 3P IDs are allowed for the IMPU.

Also, the indication that an IMPU is authorized to use 3P IDs may be defined within the subscription of the Multimedia Telephony service and stored in HSS as transparent/repository data.

### 3P Allowed Indicator Delivery to S-CSCF or TAS

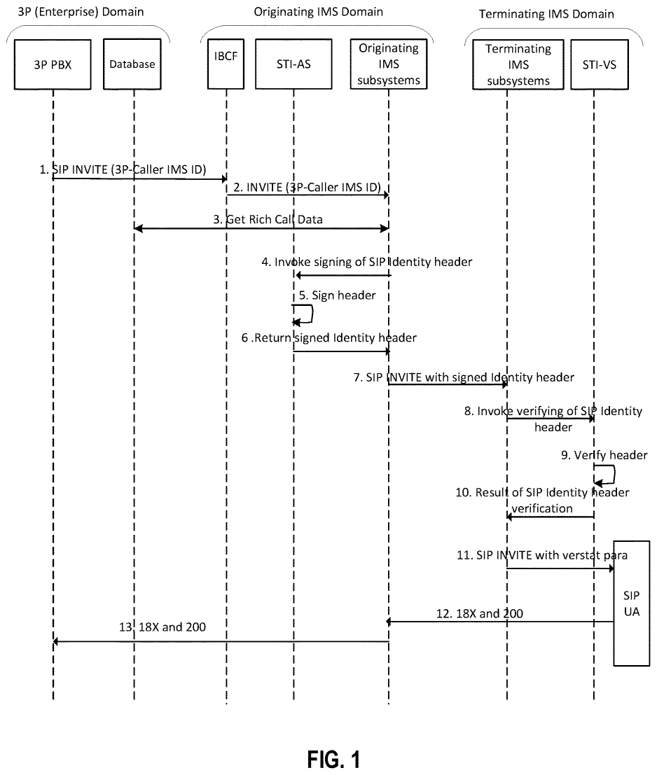

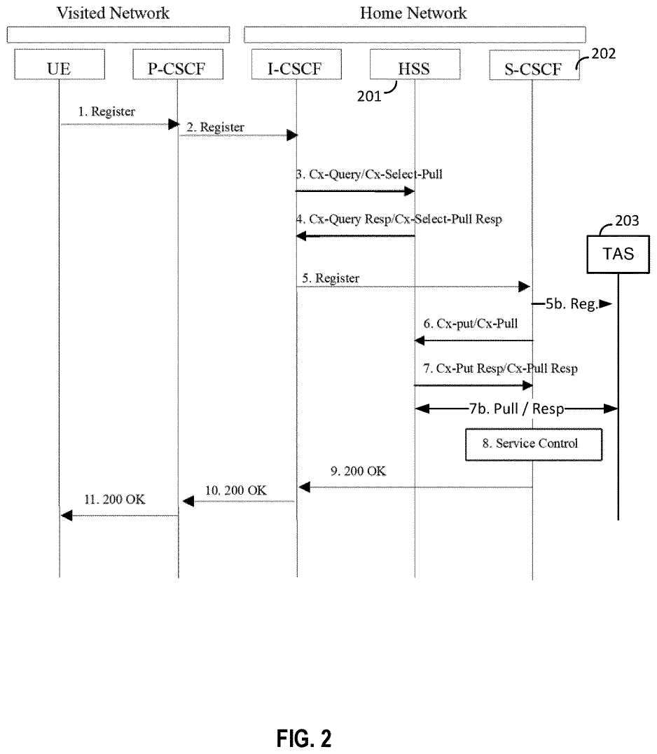

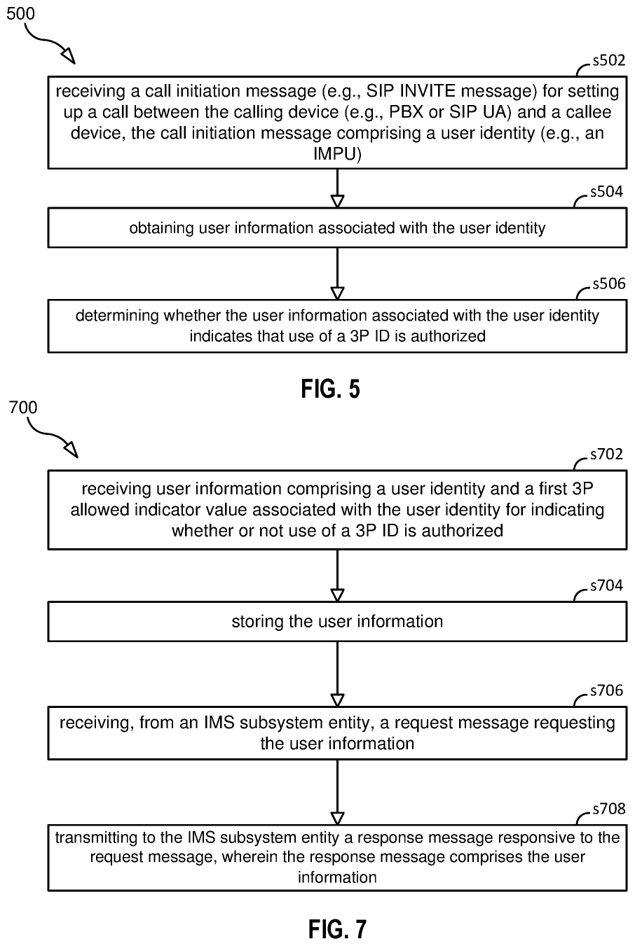

The 3P allowed indicator is included within the IMS subscription profile (user information) downloaded from the HSS by the S-CSCF during registration of the IMS subscription (e.g. registration of the PBX or registration of a SIP UA) in the originating IMS subsystem. Refer to steps 6 and 7 in IMS registration procedure defined in TS 23.228 shown FIG. 2 (which is a copy of FIG. 5-1 from TS 23.228). The steps shown in FIG. 2 are described below.
1. After the UE has obtained IP connectivity, it can perform the IM registration. To do so, the UE sends the Register information flow to the proxy (Public User Identity, Private User Identity, home network domain name, UE IP address, Instance Identifier, GRUU Support Indication).
2. Upon receipt of the register information flow, the P-CSCF shall examine the “home domain name” to discover the entry point to the home network (i.e. the I-CSCF). The proxy shall send the Register information flow to the I-CSCF (P-CSCF address/name, Public User Identity, Private User Identity, P-CSCF network identifier, UE IP address). A name-address resolution mechanism is utilized in order to determine the address of the home network from the home domain name. The P-CSCF network identifier is a string that identifies at the home network, the network where the P-CSCF is located (e.g., the P-CSCF network identifier may be the domain name of the P-CSCF network).
3. The I-CSCF shall send the Cx-Query/Cx-Select-Pull information flow to the HSS 201 (Public User Identity, Private User Identity, P-CSCF network identifier). The HSS shall check whether the user is registered already. The HSS shall indicate whether the user is allowed to register in that P-CSCF network (identified by the P-CSCF network identifier) according to the User subscription and operator limitations/restrictions if any.
4. Cx-Query Resp/Cx-Select-Pull Resp is sent from the HSS to the I-CSCF. It shall contain the S-CSCF name, if it is known by the HSS, or the S-CSCF capabilities, if it is necessary to select a new S-CSCF. When capabilities are returned, the I-CSCF shall construct a name from the capabilities returned. If the checking in HSS was not successful the Cx-Query Resp shall reject the registration attempt.
5. The I-CSCF, using the name of the S-CSCF, shall determine the address of the S-CSCF through a name-address resolution mechanism. The name-address resolution mechanism is allowed to take the load information of the S-CSCFs (e.g. obtained using network management procedures) into consideration when deciding the address of the S-CSCF. The I-CSCF also determines the name of a suitable home network contact point, possibly based on information received from the HSS. I-CSCF shall then send the register information flow (P-CSCF address/name, Public User Identity, Private User Identity, P-CSCF network identifier, UE IP address to the selected S-CSCF. The home network contact point will be used by the P-CSCF to forward session initiation signaling to the home network. The S-CSCF shall reject the registration if the number of registered contact addresses for a Public User Identity from the same UE exceeds the limit of simultaneous registrations configured at the S-CSCF. The S-CSCF shall also reject the registration from separate UEs if the allowed number of simultaneous registrations according to the S-CSCF configuration or per subscribed value for a Public User Identity received from the HSS exceeds the limit of simultaneous registrations. The S-CSCF shall store the P-CSCF address/name, as supplied by the visited network. This represents the address/name that the home network forwards the subsequent terminating session signaling to the UE. The S-CSCF shall store the P-CSCF Network ID information.
6. The S-CSCF 202 shall send Cx-Put/Cx-Pull (Public User Identity, Private User Identity, S-CSCF name) to the HSS.
7. The HSS shall store the S-CSCF name for that user and return the information flow Cx-Put Resp/Cx-Pull Resp (user information) to the S-CSCF. The user information passed from the HSS to the S-CSCF shall include one or more names/addresses information which can be used to access the platform(s) used for service control while the user is registered at this S-CSCF. The S-CSCF shall store the information for the indicated user. In addition to the names/addresses information, security information may also be sent for use within the S-CSCF. Advantageously, as discussed above, the user information stored in the HSS and provided to the S-CSCF is extended to include at least one 3P allowed indicator. For example, the operator owning the IMS system provisions IMPIs/IMPUs and the corresponding user information in the HSS via provisioning interfaces that are not defined by 3GPP. Hence, in some embodiments, the operator includes the 3P allowed indicator(s) in the user information that it provisions to the HSS.
8. Based on the filter criteria, the S-CSCF shall send register information to the service control platform and perform whatever service control procedures are appropriate.
9. The S-CSCF shall return the 200 OK information flow (home network contact information, a GRUU set) to the I-CSCF.
10. The I-CSCF shall send information flow 200 OK (home network contact information, a GRUU set) to the P-CSCF. The I-CSCF shall release all registration information after sending information flow 200 OK.
11. The P-CSCF shall store the home network contact information, and shall send information flow 200 OK (a GRUU set) to the UE. The P-CSCF may subscribe to notifications of the status of the IMS Signaling connectivity from PCRF/PCF (see TS 23.203 [54] and TS 23.503 [95] for more details). If the S-CSCF receives the priority information of the MPS subscribed-UE as a part of user profile from the HSS, the S-CSCF provides the priority information to the P-CSCF and the P-CSCF stores this information for the MPS-subscribed UE

As shown in FIG. 2 and described above, in step 6 the S-CSCF send to the HSS a request message (e.g., Cx-Put/Cx-Pull (Public User Identity, Private User Identity, S-CSCF name), and in step 7 the HSS responds to the request by providing to the S-CSCF user information associated with an IMS identity (e.g., IMPU). This user information includes the 3P allowed indicator(s) that indicate whether 3P IDs are allowed for the IMS identity.

Alternatively, if the indication that an IMPU is authorized to use 3P IDs is defined within the subscription of the Multimedia Telephony service and stored in HSS as transparent/repository data, the telephony application server (TAS) 203 (a.k.a., “MMTel AS”) will retrieve the indication from HSS together with the rest of transparent/repository data associated to the IMPU from the HSS via Sh reference point. This is illustrated in FIG. 2, which shows the TAS receiving the registration message from the S-CSCF (step 5b of FIG. 2) and then pulling the subscription of the Multimedia Telephony service and stored in HSS (step 7b of FIG. 2).

### 3P Allowed Indicator Enforcement

In some embodiments, the enforcement of the authorization of whether the IMS subscription (or IMPI or IMPU) can use 3P IDs is delegated to the S-CSCF and it is executed in the S-CSCF during the mobile originating procedure (e.g., executed by the S-CSCF in response to receiving a SIP INVITE message), based on the IMS subscription profile downloaded from HSS during IMS registration. Alternatively, if the indication that an IMPU is authorized to use 3P IDs is defined within the subscription of the Multimedia Telephony service and stored in HSS as transparent/repository data, then, in such an embodiment, the enforcement of the authorization of whether the IMPU can use 3P IDs is delegated to the TAS instead.

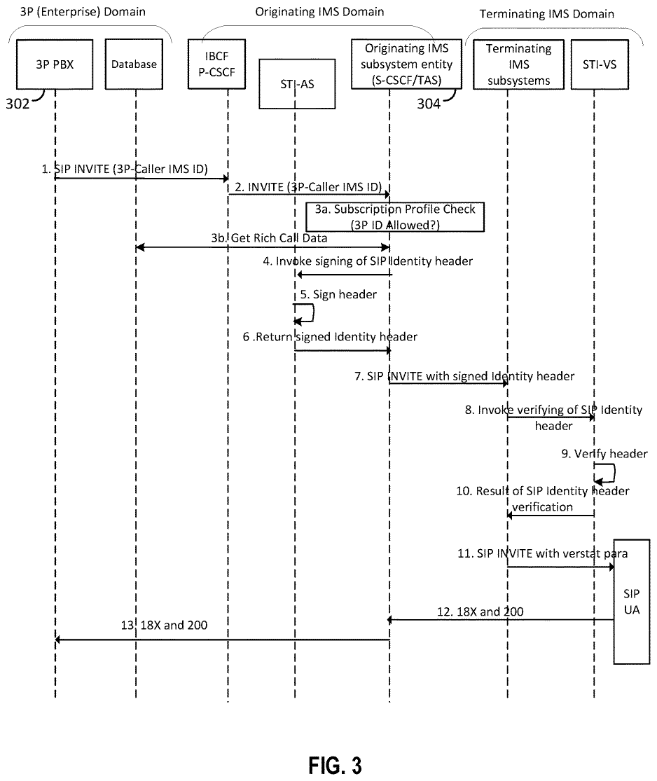

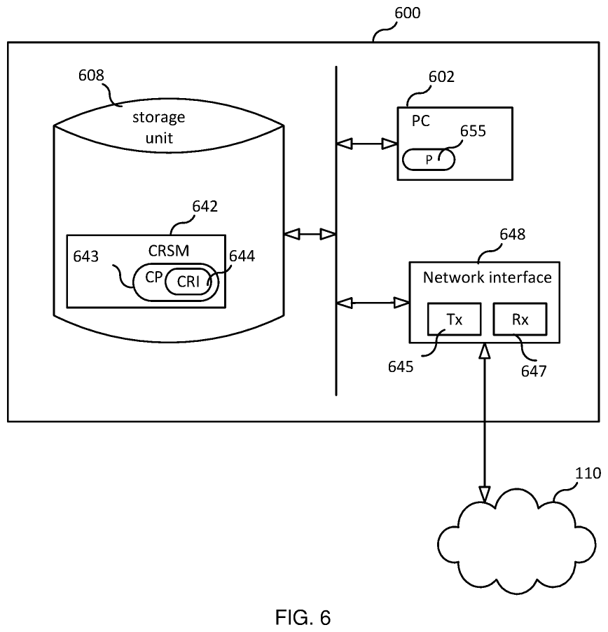

In one embodiment, the procedure defined in FIG. 6.1.2.2-1 in TR 33.890 (see FIG. 1), is modified as shown in FIG. 3. Specifically, step 3 of FIG. 1 is now step 3b and a new step (step 3a) is added. Step 3a is added to explicitly include the authorization of whether the IMS subscription can use 3P IDs based on the 3P allowed indicator included in the subscription profile. Step 3a and 3b can be described as follows:
3a. The originating IMS subsystem entity 304 (e.g., S-CSFC and/or TAS) checks whether the IMS subscription of the calling PBX is authorized to use 3P IDs. In order to do this authorization, the S-CSCF or TAS in the originating IMS subsystem checks in the IMS subscription profile downloaded from the HSS during registration of the calling PBX if the PBX is authorized to use 3P IDs.
3b. If the PBX is authorized to use 3P IDs, the originating IMS subsystem gets Rich Call Data of 3P subscriber from the Database based on the received IMS identity. If no RCD data exists for this user (IMS identity), the rest of 3P ID related steps are not executed during the call set-up. The call continues without presenting 3P ID to the called endpoint. If no 3P ID is received in the SIP INVITE from the PBX, suppression of a Database lookup can be optionally applied based on a local policy. If there is a mismatch between the received 3P ID in the SIP INVITE and data retrieved from the Database based on the IMS identity, it is governed by a local policy of the originating IMS subsystem how the population of the Rich Call Data into the SIP Identity header will be done.

If the PBX is not authorized to use 3P IDs, then the originating IMS subsystem ignores the 3P ID within the SIP INVITE (if present) and do not execute the rest of 3P ID related steps during the call set-up. The call continues without presenting 3P ID to the called endpoint.

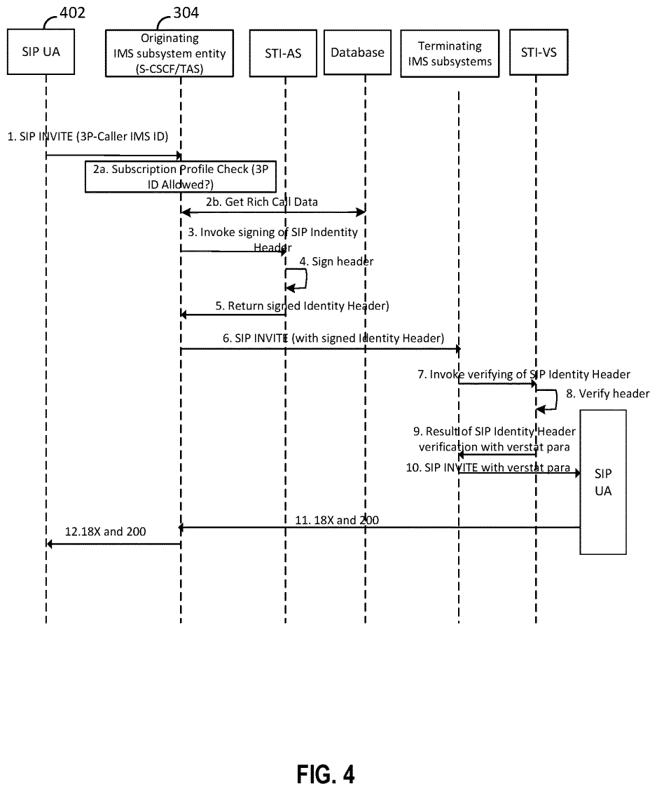

FIG. 4 illustrates another embodiment in which a 3P ID is used by a user (a.k.a., 3P subscriber) connected directly to the originating IMS subsystem. The steps shown in FIG. 4 are described below.
1. The 3P subscriber (SIP UA) sends a SIP INVITE that contains an IMS Identity (e.g., IMPU of the caller) and may or may not contain the 3P ID.
2a. The originating IMS subsystem checks whether the IMS subscription of the calling UE is authorized to use 3P IDs. In order to do this authorization, the S-CSCF (or TAS) in the originating IMS subsystem checks in the IMS subscription profile downloaded from the HSS during registration of the SIP UA if the SIP UA is authorized to use 3P IDs.
2b. If the UE is authorized to use 3P IDs, the originating IMS subsystem gets Rich Call Data (RCD) of 3P subscriber from the Database based on the received IMS identity. If no RCD data exist for this user (IMS identity), the rest of 3P ID related steps are not executed during the call set-up. The call continues without presenting 3P ID to the called endpoint.

If the UE is not authorized to use 3P IDs, then the originating IMS subsystem ignores the 3P ID within the SIP INVITE (if present) and do not execute the rest of 3P ID related steps during the call set-up. The call continues without presenting 3P ID to the called endpoint.

If no third-party ID info is received in the SIP INVITE from the UE, suppression of a Database lookup can be optionally applied based on a local policy. If there is a mismatch between the received 3P ID in the SIP INVITE and data retrieved from the Database based on the IMS identity, it is governed by a local policy of the originating IMS subsystem how the population of the Rich Call Data into the SIP Identity header will be done.
3. The originating IMS subsystem adds a P-Asserted-Identity header field asserting the telephone number and rich call data of the SIP UA and invokes the STI-AS to sign the Identity header based on FIG. 6.1.2.1-2: SHAKEN Reference Architecture and TS 24.229 [4].
4. STI-AS interacts with SKS (not shown in the figure) and signs the SIP identity header according to STIR/SHARKEN framework and draft-ietf-stir-passport-rcd-18.
5. STI-AS returns the signed SIP identity header back to IMS subsystem.
6. The originating IMS subsystems, through standard solution, routes the call to the egress IBCF. Then SIP INVITE is routed over the NNI through the standard inter-domain routing configuration. The terminating service provider's ingress IBCF receives the INVITE over the NNI and forwards to terminating IMS subsystems.
7. The terminating IMS subsystems invoke the STI-VS to verify the signed SIP identity header.
8. STI-VS interacts with STI-CR to validate the certificate and extracts public key and verify the signature in the Identity header field, which validates the Caller ID and rich call data when signing the INVITE on the originating STI-AS based on FIG. 6.X.2.1-2: SHAKEN Reference Architecture and TS 24.229 [4].
9. Depending on the result of the STI validation, STI-VS determines that the call is to be completed with an appropriate indicator and the result is passed back to terminating IMS subsystem which continues to set up the call to the terminating SIP UA. If the Caller ID is validated OK but not the Rich Call Data, the call can continue but without showing name card info to terminating SIP UA.
10. The SIP INVITE with verstat parameter is sent to terminating SIP UA.
11. The terminating SIP UA sends 18X and 200 to originating IMS subsystem.
12. Originating IMS subsystem sends 18X and 200 to originating SIP UA. The call continues following standard solution.

FIG. 5 is a flow chart illustrating a process 500, according to an embodiment, for handling a call from a calling device (e.g. PBX 302 or SIP UA 402). Process 500 is performed by IMS subsystem entity 304 (e.g., S-CSCF 202 and/or TAS 203). Process 500 may begin in step s502. Step s502 comprises receiving a call initiation message (e.g., SIP INVITE message) for setting up a call between the calling device (e.g., PBX or SIP UA) and a callee device, the call initiation message comprising a user identity (e.g., an IMPU). Step s504 comprises, after receiving the call initiation message, determining whether user information associated with the user identity indicates that use of a 3P ID is authorized.

FIG. 7 is a flow chart illustrating a process 700, according to an embodiment. Process 700 is performed by a subscriber server (e.g., HSS 201). Process 700 may begin in step s702. Step s702 comprises receiving user information comprising a user identity and a first third-party, 3P, allowed indicator value associated with the user identity for indicating whether or not use of a third-party, 3P, identifier, ID, is authorized. Step s704 comprises storing the user information. Step s706 comprises receiving, from an IMS subsystem entity 304, a request message requesting the user information. Step s708 comprises transmitting to the IMS subsystem entity a response message responsive to the request message, wherein the response message comprises the user information.

FIG. 6 is a block diagram of apparatus 600, according to some embodiments, for implementing IMS subsystem entity 304. As shown in FIG. 6, apparatus 600 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 600 may be a distributed computing apparatus); at least one network interface 648 (e.g., a physical interface or air interface) comprising a transmitter (Tx) 645 and a receiver (Rx) 647 for enabling apparatus 600 to transmit data to and receive data from other nodes connected to a network 110 (e.g., an Internet Protocol (IP) network) to which network interface 648 is connected (physically or wirelessly) (e.g., network interface 648 may be coupled to an antenna arrangement comprising one or more antennas for enabling apparatus 600 to wirelessly transmit/receive data); and a storage unit (a.k.a., “data storage system”) 608, which may include one or more non-volatile storage devices and/or one or more volatile storage devices. In embodiments where PC 602 includes a programmable processor, a computer readable storage medium (CRSM) 642 may be provided. CRSM 642 may store a computer program (CP) 643 comprising computer readable instructions (CRI) 644. CRSM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes apparatus 600 to perform steps described herein (e.g., steps described herein with reference to the flow charts). In other embodiments, apparatus 600 may be configured to perform steps described herein without the need for code. That is, for example, PC 602 may consist merely of one or more ASICs. Hence, the features of the embodiments described herein may be implemented in hardware and/or software.

### SUMMARY OF VARIOUS EMBODIMENTS

A1. A method 500 for handling a call from a calling device 302, 402, the method comprising: receiving a call initiation message (e.g., SIP INVITE message) for setting up a call between the calling device (e.g., PBX or SIP UA) and a callee device, the call initiation message comprising a user identity (e.g., an IMPU); obtaining user information associated with the user identity; and after receiving the call initiation message, determining whether the user information associated with the user identity indicates that use of a third-party, 3P, identifier, ID, is authorized.
A2. The method of embodiment A1, further comprising: during a registration procedure for registering the user identity, pulling the user information from a subscriber server 201 (e.g., a Home Subscriber Server (HSS)).
A3. The method of embodiment A1 or A2, wherein the user information comprises a private user identity (e.g., IMPI), the user information further comprises a first 3P allowed indicator value associated with the private user identity, and the step of determining whether the user information associated with the user identity indicates that use of a 3P ID is authorized comprises determining whether the first 3P allowed indicator value indicates that use of a 3P ID is authorized or not.
A4. The method of embodiment A3, wherein the user identity is a public user identity (e.g., IMPU), the user information further comprises the public user identity, the user information further comprises a second 3P allowed indicator value associated with the public user identity, and the step of determining whether the user information associated with the user identity indicates that use of a 3P ID is authorized further comprises determining whether the second 3P allowed indicator value indicates that use of a 3P ID is authorized or not.
A5. The method of any one of embodiments A1-A2, wherein the user identity is a public user identity (e.g., IMPU), the user information comprises the public user identity, the step of determining whether the user information associated with the user identity indicates that use of a 3P ID is authorized comprises determining whether the user information further comprises a display name associated with the public user identity.
A6. The method of any one of embodiments A1-A4, wherein the step of determining whether the user information associated with the user identity indicates that use of a 3P ID is authorized comprises determining whether the user information further comprises a display name set to a particular value (e.g., set to “RCD”).
B1. An Internet Protocol Multimedia System (IMS) subsystem entity 304, the IMS entity being configured to perform a process comprising: receiving a call initiation message (e.g., SIP INVITE message) for setting up a call between the calling device (e.g., PBX or SIP UA) and a callee device, the call initiation message comprising a user identity (e.g., an IMPU); and after receiving the call initiation message, determining whether user information associated with the user identity indicates that use of a third-party, 3P, identifier, ID, is authorized.
B2. The IMS subsystem entity of embodiment B1, wherein the process further comprises: prior to receiving the call initiation message, obtaining the user information from a subscriber server (e.g., a Home Subscriber Server (HSS)).
B3. The IMS subsystem entity of embodiment B1 or B2, wherein the user information comprises a private user identity (e.g., IMPI), the user information further comprises a first 3P allowed indicator value associated with the private user identity, and the step of determining whether the user information associated with the user identity indicates that use of a 3P ID is authorized comprises determining whether the first 3P allowed indicator value indicates that use of a 3P ID is authorized or not.
B4. The IMS subsystem entity of embodiment B3, wherein the user identity is a public user identity (e.g., IMPU), the user information further comprises the public user identity, the user information further comprises a second 3P allowed indicator value associated with the public user identity, and the step of determining whether the user information associated with the user identity indicates that use of a 3P ID is authorized further comprises determining whether the second 3P allowed indicator value indicates that use of a 3P ID is authorized or not.
B5. The IMS subsystem entity of any one of embodiments B1-B2, wherein the user identity is a public user identity (e.g., IMPU), the user information comprises the public user identity, the step of determining whether the user information associated with the user identity indicates that use of a 3P ID is authorized comprises determining whether the user information further comprises a display name associated with the public user identity.
B6. The IMS subsystem entity of any one of embodiments B1-B4, wherein the step of determining whether the user information associated with the user identity indicates that use of a 3P ID is authorized comprises determining whether the user information further comprises a display name set to a particular value (e.g., set to “RCD”).
B7. The IMS subsystem entity of embodiment B1, wherein the IMS subsystem entity is a Server-Call Session Control Function, S-CSCF 202, or a telephony application server, TAS 203.
C1. A method 700 performed by a subscriber server 201, the method comprising: receiving user information comprising a user identity and a first third-party, 3P, allowed indicator value associated with the user identity for indicating whether or not use of a third-party, 3P, identifier, ID, is authorized; storing the user information; receiving, from an IMS subsystem entity 304, a request message requesting the user information; and transmitting to the IMS subsystem entity a response message responsive to the request message, wherein the response message comprises the user information.
C2. The method of embodiment C1, wherein the user information comprises a private user identity (e.g., IMPI), and the first 3P allowed indicator value is associated with the private user identity.
C3. The method of embodiment C1, wherein the user information further comprises a public user identity (e.g., IMPU), and the first 3P allowed indicator value is associated with the public user identity.
C4. The method of embodiment C1, wherein the user information comprises a private user identity (e.g., IMPI), the user information further comprises a first public user identity (e.g., 1st IMPU), the user information further comprises a second public user identity (e.g., 2nd IMPU), the first 3P allowed indicator value is associated with the public user identity, a second 3P allowed indicator value is associated with the private user identity, the second 3P allowed indicator value indicates that 3P IDs are allowed for the second public user identity, and the first 3P allowed indicator value indicates that 3P IDs are not allowed for the first public user identity.
D1. A computer program 643 comprising instructions 644 which when executed by processing circuitry 602 of an apparatus 600 causes the apparatus to perform the method of any one of embodiments A1-A6.
D2. A carrier containing the computer program of embodiment C1, wherein the carrier is one of an electronic signal, an optical signal, a radio signal, and a computer readable storage medium 642.
E1. An apparatus 600 configured to perform the method of any one of embodiments A1-A16 or C1-C4.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### Abbreviations

| | |
|---|---|
| 3P | third-Party (or 3rd Party) |
| HSS | Home Subscriber System |
| IBCF | Interconnect Border Control Function |
| I-CSCF | Interrogating- Call Session Control Function |
| IMPI | IMS private user identity |
| IMPU | IMS public user identity |
| IMS | IP-Multimedia Subsystem |
| PBX | Private Branch Exchange |
| P-CSCF | Proxy - Call Session Control Function |
| S-CSCF | Server - Call Session Control Function |
| SIP | Session Initiation Protocol |
| SIP UA | SIP User Agent |
| STI-AS | Secure Telephone Identity Authentication Service |
| STI-VS | Secure Telephone Identity Verification Service |
| TAS | Telephony Application Server |

1. A method for handling a call from a calling device, the method comprising:
receiving a call initiation message for setting up a call between the calling device and a callee device, the call initiation message comprising a user identity;
obtaining user information associated with the user identity; and
after receiving the call initiation message, determining whether the user information associated with the user identity indicates that use of a third-party identifier is authorized.

2. The method of claim 1, wherein
obtaining the user information comprises pulling the user information from a subscriber server during a registration procedure for registering the user identity.

3. The method of claim 1, wherein
the user information comprises a private user identity,
the user information further comprises a first 3P allowed indicator value associated with the private user identity, and
the step of determining whether the user information associated with the user identity indicates that use of a 3P ID is authorized comprises determining whether the first 3P allowed indicator value indicates that use of a 3P ID is authorized or not.

4-6. (canceled)

7. An Internet Protocol Multimedia System (IMS) subsystem entity, the IMS subsystem entity being configured to perform a process comprising:
receiving a call initiation message for setting up a call between the calling device and a callee device, the call initiation message comprising a user identity; and
after receiving the call initiation message, determining whether user information associated with the user identity indicates that use of a third-party identifier (3P ID) is authorized.

8. The IMS subsystem entity of claim 7, wherein the process further comprises:
prior to receiving the call initiation message, obtaining the user information from a subscriber server.

9. The IMS subsystem entity of claim 7, wherein
the user information comprises a private user identity,
the user information further comprises a first 3P allowed indicator value associated with the private user identity, and
the step of determining whether the user information associated with the user identity indicates that use of a 3P ID is authorized comprises determining whether the first 3P allowed indicator value indicates that use of a 3P ID is authorized or not.

10. The IMS subsystem entity of claim 9, wherein
the user identity is a public user identity,
the user information further comprises the public user identity,
the user information further comprises a second 3P allowed indicator value associated with the public user identity, and
the step of determining whether the user information associated with the user identity indicates that use of a 3P ID is authorized further comprises determining whether the second 3P allowed indicator value indicates that use of a 3P ID is authorized or not.

11. The IMS subsystem entity of claim 7, wherein
the user identity is a public user identity,
the user information comprises the public user identity,
the step of determining whether the user information associated with the user identity indicates that use of a 3P ID is authorized comprises determining whether the user information further comprises a display name associated with the public user identity.

12. The IMS subsystem entity of claim 7, wherein
the step of determining whether the user information associated with the user identity indicates that use of a 3P ID is authorized comprises determining whether the user information further comprises a display name set to a particular value.

13. The IMS subsystem entity of claim 7, wherein
the IMS subsystem entity is a Server-Call Session Control Function or
the IMS subsystem entity is a telephony application server.

14. (canceled)

15. A method performed by a subscriber server, the method comprising:
receiving user information comprising a user identity and a first third-party (3P) allowed indicator value associated with the user identity for indicating whether or not use of a 3P identifier (3P ID) is authorized;
storing the user information;
receiving, from an IMS subsystem entity, a request message requesting the user information; and
transmitting to the IMS subsystem entity a response message responsive to the request message, wherein the response message comprises the user information.

16. The method of claim 15, wherein
the user information further comprises a private user identity, and
the first 3P allowed indicator value is associated with the private user identity.

17. The method of claim 15, wherein
the user information further comprises a public user identity, and
the first 3P allowed indicator value is associated with the public user identity.

18. The method of claim 15, wherein
the user information further comprises a private user identity,
the user information further comprises a first public user identity,
the user information further comprises a second public user identity,
the first 3P allowed indicator value is associated with the public user identity,
a second 3P allowed indicator value is associated with the private user identity,
the second 3P allowed indicator value indicates that 3P IDs are allowed for the second public user identity, and
the first 3P allowed indicator value indicates that 3P IDs are not allowed for the first public user identity.

19. A non-transitory computer readable storage medium storing a computer program comprising instructions which when executed by processing circuitry of an apparatus causes the apparatus to perform the method of claim 1.

20. A non-transitory computer readable storage medium storing a computer program comprising instructions which when executed by processing circuitry of an apparatus causes the apparatus to perform the method of claim 15.

21. A subscriber server configured to perform a method comprising:
receiving user information comprising a user identity and a first third-party (3P) allowed indicator value associated with the user identity for indicating whether or not use of a 3P identifier (3P ID) is authorized;
storing the user information;
receiving, from an IMS subsystem entity, a request message requesting the user information; and
transmitting to the IMS subsystem entity a response message responsive to the request message, wherein the response message comprises the user information.

22. The subscriber server of claim 21, wherein
the user information further comprises a private user identity, and
the first 3P allowed indicator value is associated with the private user identity.

23. The subscriber server of claim 21, wherein
the user information further comprises a public user identity, and
the first 3P allowed indicator value is associated with the public user identity.

24. The subscriber server of claim 21, wherein
the user information further comprises a private user identity,
the user information further comprises a first public user identity,
the user information further comprises a second public user identity,
the first 3P allowed indicator value is associated with the public user identity,
a second 3P allowed indicator value is associated with the private user identity,
the second 3P allowed indicator value indicates that 3P IDs are allowed for the second public user identity, and
the first 3P allowed indicator value indicates that 3P IDs are not allowed for the first public user identity.
